(19) United States
(12) Patent Application Publication
(10) Pub. No.: US 2014/0008303 A1
(43) Pub. Date: Jan. 9, 2014

(54) IN-SITU SELECTIVE CONTAMINANT ADSORPTION IN URINALS AND TOILETS

(71) Applicant: UNIVERSITY OF FLORIDA RESEARCH FOUNDATION, INC., Gainesville, FL (US)

(72) Inventor: TREAVOR BOYER, GAINESVILLE, FL (US)

(21) Appl. No.: 13/938,111

(22) Filed: Jul. 9, 2013

Related U.S. Application Data
(60) Provisional application No. 61/669,183, filed on Jul. 9, 2012.

(51) Int. Cl. B01J 47/02

(52) U.S. Cl. CPC B01J 47/022
USPC 210/670; 210/287; 210/85; 210/681

(57) ABSTRACT

An absorption device for use with a waterless urinal comprises an exchange container containing at least one ion exchange resin. The exchange container comprises a housing and at least one resin support. The ion exchange resin can be a cation exchange resin that removes calcium and magnesium ions from urine. The ion exchange resin can be an anion exchange resin that removes anionic pharmaceuticals from urine. The ion exchange resin can be a hybrid anion exchange resin that removes phosphorous comprising anions from urine. The absorption device permits the removal of cations that result in scale and blockage of waterless urinal drain pipes and removes ions that otherwise would require treatment at wastewater treatment facilities.

### CROSS-REFERENCE TO RELATED APPLICATION

The present application claims the benefit of U.S. Provisional Application Ser. No. 61/669,183, filed Jul. 9, 2013, which is hereby incorporated by reference herein in its entirety, including any figures, tables, or drawings.

This invention was made with government support under CBET-1150790 awarded by the National Science Foundation. The government has certain rights in the invention.

### BACKGROUND OF INVENTION

Urine contributes greater than 50% of the nitrogen (N) and phosphorus (P) to domestic wastewater treatment plants (WWTP). The size and the cost of WWTPs could be dramatically reduced if the load of N and P were eliminated at the source, decreasing the structural footprint, energy demand and associated costs of wastewater treatment. Source separation of urine is currently under consideration as a sustainable alternative to conventional wastewater systems (Larsen et al., Environ. Sci. Technol. 2009, 43(16), 6121-6125). However, until recently, this treatment option was considered feasible only for areas where connection to large conventional wastewater systems was not available. Additionally, approximately 50% of human pharmaceuticals are excreted through urine, making source-separation and treatment of urine a promising solution to the problem of micropollutants entering surface waters (Lienert et al., Water Sci. Technol. 2007, 56(5), 87-96).

Environmental benefits could be significant if WWTP effluent concentrations of N, P, and pharmaceuticals were reduced. Both N and P are considered primary causes of eutrophication in receiving water bodies. Increased cultural awareness of sustainability has resulted in implementation of water-conserving facilities, such as waterless urinals. The popularity of waterless urinals has suffered in part because of the maintenance issues their use incurs. Without water to flush out the urine, precipitation of minerals causes blockages in the traps, pipes, and storage tanks of waterless urinals (Udert et al., Water Res. 2003, 37, 2667-2677). Urease, an enzyme produced by ubiquitous bacteria, rapidly decomposes urea into ammonia and bicarbonate causing a pH increase, which promotes the precipitation of struvite, hydroxyapatite, and other minerals.

Ion exchange resins can remove calcium (Ca) and magnesium (Mg) or other cations from an aqueous solution; however, there is limited data investigating ion exchange in urine or under conditions typical of urinals and toilets. Ion exchange has the potential to use urine as a recovery source of P as urine is about 1% of all wastewater and about 5% of all P in wastewater, yet this has not been an approach taken as a source of P. The removal of drugs from wastewater is an increasing problem that can be addressed by removal from urine as most pharmaceuticals consumed are excreted in urine or as their metabolites. Furthermore, there is no on-site treatment technology for treatment of urine that removes hardness but does not increase the facility's required maintenance.

### BRIEF SUMMARY

Embodiments of the invention are directed to an absorption device, where an exchange container, comprising a housing and at least one resin support contains at least one ion exchange resin. The absorption device is constructed for placement at the urine entry to the drain of a waterless urinal such that urine or other liquid is caused to flow through the ion exchange resin. The ion exchange resin can be a cation exchange resin for the removal of Ca and Mg ions, which are known to cause precipitation and, ultimately, blockage within the traps of waterless urinal drains. The ion exchange resin can be an anion exchange resin for the removal of anionic drugs from urine, which left untreated the drugs pass through WWTPs and ultimately the drinking water sources of communities. Phosphorous containing anions can be removed using hybrid anion exchange (HAIX) resins.

The absorption devices can be connected to the drain of the urinal by a means of attachment that can position the absorption device in the drain or secure it within the drain. The absorption device can include a colorimetric indicator at the liquid exit of the device such that a quick visual inspection can determine if the quantity of urine has exceeded the capacity of the absorption device and it is in need of replacement with a new or regenerated absorption device.

### BRIEF DESCRIPTION OF DRAWINGS

FIG. 1 shows an absorption device, according to an embodiment of the invention, where the urine flows from the top to the bottom of the ion exchange resin bed.

FIG. 2 shows an absorption device, according to an embodiment of the invention, where the urine flows from the bottom to the top of the ion exchange resin bed.

FIG. 3 shows a plot of the average Ca removal during intermittent flow conditions expressed as a ratio of concentration at some cumulative volume over initial Ca concentration, C₀=191 mg/L, from an absorption device, according to an embodiment of the invention.

FIG. 4 shows a plot of the average Mg removal during intermittent flow conditions expressed as a ratio of concentration at some cumulative volume over initial Mg concentration, C₀=74 mg/L, from an absorption device, according to an embodiment of the invention.

FIG. 5 shows a plot of the diclofenac removal during intermittent flow conditions expressed as a ratio of concentration at some cumulative volume over initial diclofenac concentration, C₀=1.2 mmol/L, from an absorption device, according to an embodiment of the invention.

FIG. 6 shows a plot of the effect of mixing time on diclofenac removal by A-520E anion exchange resin (8 mL/L) in fresh urine (pH 6) with an initial diclofenac concentration 0.1 mM, according to an embodiment of the invention.

FIG. 7 shows a plot of the effect of urine composition on equilibrium (24 h) removal of diclofenac (DCF) by A520E anion exchange resin in fresh urine (pH 6) at varying initial DCF concentration (0.1 mM or 0.2 mM), according to an embodiment of the invention.

FIG. 8 shows a plot of the effect of competing anions phosphate (PO₄⁻P) and citrate (Cit) on equilibrium (24 h) removal of diclofenac (DCF) by A-520E anion exchange resin in fresh urine (pH 6), according to an embodiment of the invention.

FIG. 9 shows a plot of the effect of anion exchange resin properties on equilibrium (24 h) removal of diclofenac in fresh urine (pH 6) at an initial diclofenac concentration 0.2 mM, according to an embodiment of the invention.

FIG. 10 shows a plot of the effect of mixing time on phosphate concentration in urine using hybrid anion exchange resin with a mixing intensity of 200 rpm and a resin dose of 100 mL/L of fresh urine, where data are mean±one standard deviation for duplicate samples, according to an embodiment of the invention.

FIG. 11 shows a plot of the effect of mixing time and resin dose on phosphate concentration in fresh urine using hybrid anion exchange resin with a mixing intensity of 200 rpm, where data are mean±one standard deviation for triplicate samples, according to an embodiment of the invention.

FIG. 12 shows a plot of the effect of mixing time and mixing intensity on phosphate concentration in urine using hybrid anion exchange resin with fresh urine at 714 mg P/L and 100 mL/L resin, where data are mean±one standard deviation for triplicate samples, according to an embodiment of the invention.

FIG. 13 shows a plot of the Effect of resin dose on equilibrium phosphate concentration in urine using a hybrid anion exchange resin with mixing for 2 h at 200 rpm, an initial phosphate concentration of 675 mg P/L in fresh urine, where data are mean±one standard deviation for triplicate samples, according to an embodiment of the invention.

FIG. 14 shows a plot of the effect of resin dose on equilibrium concentration of sulfate, chloride, and phosphate in urine using hybrid anion exchange resin mixing for 2 h at 200 rpm with fresh urine with initial concentrations of 3040 mg/L sulfate, 3820 mg/L chloride, and 686 mg P/L phosphate, where data are mean±one standard deviation for triplicate samples, according to an embodiment of the invention.

FIG. 15 shows a plot for co-removal of diclofenac and phosphate in urine using hybrid anion exchange resin with mixing for 2 h at 200 rpm with fresh urine having initial concentrations of 0.204 mmol/L diclofenac and 704 mg P/L phosphate, where data are mean ±one standard deviation for triplicate samples, according to an embodiment of the invention.

### DETAILED DISCLOSURE

An embodiment of the invention is directed to an absorption device for the treatment of urine in a waterless urinal. The absorption device selectively removes components of urine at the site of collection to reduce or remove these components from the waste stream prior to delivery of the urine stream to a wastewater treatment center. In an embodiment of the invention, the absorption device is useful for preventing the precipitation of salts that ultimately lead to blockage in the urinal system. In embodiments of the invention, the device comprises an ion exchange resin. In an embodiment of the invention, the ion exchange resin is a cation exchange resin, which reduces the quantity of “hard” ions, such as calcium and magnesium, which lead to the salt precipitation in the drains of a urinal as urea enzymatically breaks down. In another embodiment of the invention, the ion exchange resin is an anion exchange resin that can facilitate removal of anionic drugs from urine. In another embodiment of the invention, the ion exchange resin is a hybrid anion exchange HAIX resin that can facilitate removal of phosphates from urine. In another embodiment of the invention, a mixture of a mixed bead (cationic and anionic) ion exchange resin and a HAIX resin can be used to remove “hard” cations, phosphates, and anionic pharmaceuticals. The metal of the HAIX resin can be iron or any other metal from a metal salt that can be oxidized in the presence of an anion exchange resin.

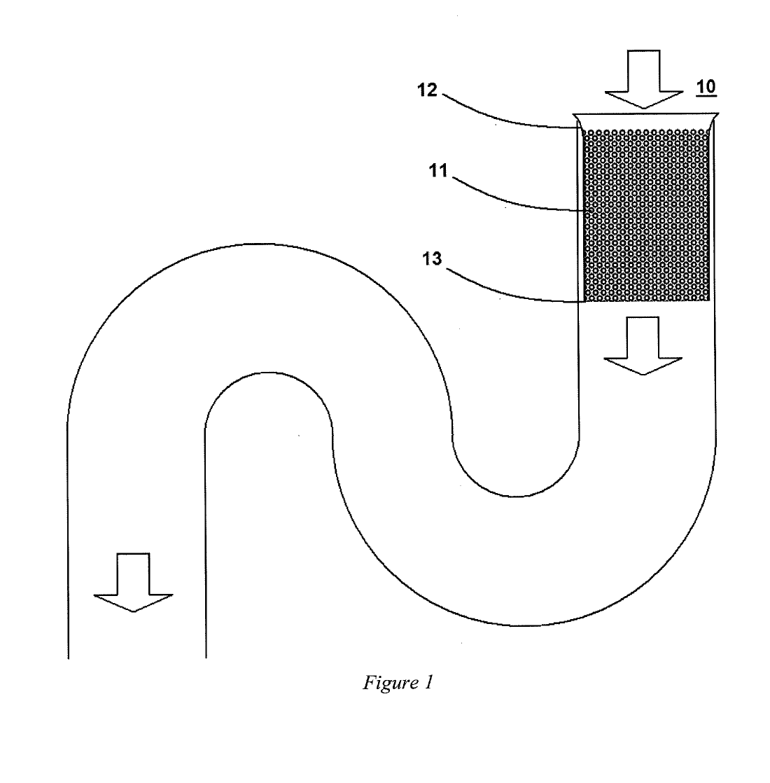

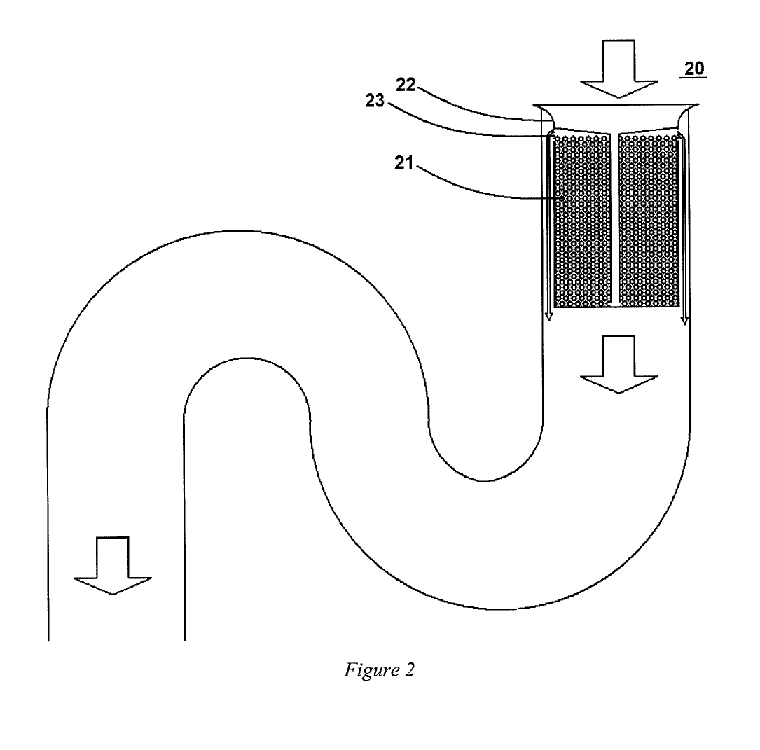

In embodiments of the invention, the absorption device comprises an ion exchange resin that resides within an exchange container comprising a housing that can reside in the drain of the urinal. The urine is obliged to pass through the ion exchange resin bed. The exchange container can be used for a period of time, depending on the frequency of urination events, the size of the exchange container, and the capacity of the resin employed. However, the efficiency of ion removal is most efficient in fresh urine rather than aged, “hydrolyzed urine” that has resided in collection facilities due to the breakdown of urine due to bacteria in large collection facilities. The absorption device, 10 and 20, of FIGS. 1 and 2, respectively, can have a variety of geometries that can result in the urine flowing through the resin bed from the top to the bottom of the ion exchange resin bed, as shown in FIG. 1, or in the reverse, as shown in FIG. 2, such that the urine enters the resin bed, from the bottom and exits from the top of the bed. The housing of the exchange container, 12 and 22, of FIGS. 1 and 2, respectively, can be constructed out of a plastic, thermoset resin, ceramic, glass, or metallic material. The absorption device, 10 and 20, of FIGS. 1 and 2, respectively, can comprise an exchange container that is rigid or flexible. Additionally, the exchange container comprises a resin support, 13 and 23, of FIGS. 1 and 2, respectively, of sufficiently small porosity to retain one or more ion exchange resins, 11 and 21, of FIGS. 1 and 2, respectively, with little or no loss of fine particles, yet of sufficiently large porosity to allow flow through the device within a desired period of time that is sufficiently rapid as to allow frequent urination events to occur without a rise in the level of urine within the exposed portion of the urinal. In general, the largest porosity resin support, which allows retention of all of the resin, is more than sufficient in size to permit a good flow of urine through the absorption device. In one embodiment of the invention, the exchange container is flexible and can be a woven or knitted fabric, allowing the housing and resin support portions of the exchange container to be the same material. The exchange container can be molded or machined to fit a specific urinal design, such that it can be rapidly fixed and removed from the urinal.

Cationic ion exchange resins can be, but are not limited to: Purolite® C-100Na/H, PFC-100Na/H, C-100 E, C-100X10, PFC-100X10, C-150, C-104, SST-60, or SGC-650C; Dow® HCR-W2, Marathon® C Na/H, HCR/HCR-S/S, HGR-W2, Marathon® C10, MSC-1 C, Marathon® MSC, MAC-3, or Monosphere 650 C; Sybron® C-249/C-267, C-249, C-299, CFP-110, or CNN; Lanxess® Monoplus S 100H, S110, Monoplus S112, or CNP-80; Thermax® T-42 Na/H, T-52, or T-42MP; Rohm & Haas® IR-120Na/H, IR-1200, IR-120, IR-122, IR-1500, IR-200, or DP-1; or ResinTech® CG8 Na/H, CG10, or SACMP. Anionic ion exchange resins can be, but are not limited to: Purolite® A-100, A-103, A-104, A-300/300E, A-400, A-500, A-500P, A-501P, A-510, A-520E, A-600, A-847, A-850, A-860, PFA-300, PFA-400, PFA-444, PFA-600, or SGA-550A; Dow® Marathon® 11, Marathon® A, Marathon® A2, Marathon® MSA, Marathon® WBA, Dowex® 22, Monosphere 550A, Monosphere 66/77 & 66, MSA-2, SBP-P*, or SBR*; Sybron® A-641, A-642, A-651, AFP-329, ASB-1, ASB-1P, ASB-2, Macro-T, or SR-7; Lanxess® Monoplus MP500, Monoplus MP600, Monoplus MP64, or MP62; Thermax® A-107, A-23, A-23P, A-27MP, A-2XMP, A-30MP, A-32, A-36MP, A-72MP, or A-9MP; Rohm & Haas® IR-4200, IR-4400, IR-4600, IRA-400, IRA-402, IRA-410, IRA-458, IRA-68, IRA-900, IRA-904, IRA-910, IRA958, or IRA-93/94; or ResinTech® SBG1, SBG1P, SBG2, SBACR1, or WBMP. Mixed bead (cationic and anionic) ion exchange resins can be, but are not limited to: Purolite® NRW-37; EX-MB SC, or PICOPURE 92; Dow® Marathon® MR3 or Monosphere MR-3 LC NG; Sybron® NM60; Thermax® MB-108P or MB-115; Rohm & Haas® IRN-150; ResinTech® MBD-10 or MBD-16. Hybrid anion exchange resins can be, but are not limited to SolmeteX PhosXnp 196 or LayneRT.

The absorption device can include a seal, for example, an o-ring or gasket, to assure that no urine is allowed to follow a path in the drain that avoids the ion exchange resin bed. The absorption device can be fixed in position within the drain of the urinal by gravity, and can be positioned with respect to slots or ridges that are complementary between the absorption device and the drain opening. According to an embodiment of the invention, the absorption device can further comprise a means of attachment, for example, threads, such that the absorption device can be screwed into the drain. The absorption device is designed such that it may be removed with appropriate tools or by hand. It is anticipated that one would wash down the urinal with clean water such that the absorption device can be removed and replaced rapidly. According to an embodiment of the invention, the absorption device can further comprise a bound indicator of Ca⁺² and Mg⁺² ion such that a color change of the binding medium can indicate that the capacity of the cation exchange resin has been exceeded and that the absorption device should be changed. For example, a bound calmagite indicator can reside on or below the exit resin support of the exchange container, such that the indicator has a blue color while the resin is removing Ca⁺² and Mg⁺², but displays a purple to red color when the capacity of the cation exchange resin has been exceeded.

The absorption device can be reusable, where the “hard ion” contaminated device is placed in a container for washing the bound “hard” ions from the ion exchange resin. In this manner, the absorption device can be recycled by a service or the user of the urinal such that the ion exchange resin can be regenerated in a sodium or hydrogen ion form for further use.

### Methods and Materials

### Synthetic Urine Preparation

The composition of synthetic urine was derived from that disclosed by Tilley et al., Environmental Technology 2008, 29(7), 807-816 and has the compositions given in Table 1, below.

Experiment 1 corresponds to removal of “hard” ions by cation exchange resin; Experiment 2 corresponds to removal of diclofenac by anion exchange resin.

TABLE 1
Simulated urine compositions (g/L)

| Compound | Experiment 1 | Experiment 2 |
|---|---|---|
| CaCl₂•2H₂O | 0.65 | 0.65 |
| MgCl₂•H₂O | 0.65 | 0.65 |
| NaCl | 4.6 | 4.6 |
| NaSO₄ | 2.3 | 2.3 |
| KCl | 1.6 | 1.6 |
| NH₄Cl | 1 | 1 |
| NH₂CONH₂ (urea) | 25 | 25 |
| Na₃citrate•H2O | 0 | 0 |
| Na₂(COO)₂ | 0 | 0 |
| KH₂PO₄ | 0 | 0 |
| C₄H₇N₃O (creatinine) | 0 | 0 |
| Diclofenac | 0 | 0.318 |

Ion exchange resins
For removal of “hard” ions, 27 g of Amberlite ® 200C cation exchange resin was used.
For diclofenac removal, 20 mL of Amberlite ® IRA-958 Cl anion exchange resin was used.

### Waterless Urinal

The absorption device was constructed as a resin supporting pouch that fits inside the upper drain of the waterless urinal, Kohler (model number k-4918), to allow urine to flow through the resin before a subsequent simulated urination event occurred and to assure no loss of resin. The pouch, which acted as the housing and the resin support of the exchange container, was constructed from a 100% nylon pantyhose. The nylon was cut approximately three inches from the toe seam at the foot of the pantyhose. The section was attached to the waterless urinal drain cap using 1-inch wide duct tape, and the ion exchange resin was inserted into the drain cap openings using a spatula and water. The drain cap and resin support pouch was placed at the drain inlet of the urinal bowl. A water based adhesive caulk was used to fix the drain cap in place to avoid any flow of urine around rather than through the resin support pouch. Before each experiment, the urinal was flushed with 10 L of water and loaded with a fresh absorption device.

The backside of the urinal was exposed for ease of sample collection. Attached to the urinal's outlet were two short 2.5-inch diameter PVC pipes draining to a funnel and 250 mL Erlenmeyer flask for sample collection. Samples were labeled, sealed, and refrigerated until analyzed. Intermittent flow experiments to evaluate the removal of “hard” ions were performed in triplicate. A single diclofenac removal experiment was performed using the same intermittent flow procedure.

### Ions

The removal of calcium and magnesium was examined without the pharmaceutical diclofenac present in the synthetic urine. The amount of diclofenac used, 1 mmol/L, represents the approximate concentration of pharmaceuticals in urine, which can vary widely. Synthetic urine mixtures were prepared by adding weighed portions of the various components and deionized (DI) water measured in a 1 L volumetric flask. The urine compositions were prepared by adding the components to a 6 L Erlenmeyer flask, diluting with 5 L DI water, and placing the flask on a hot plate stirrer at high heat and high mixing until all salts were dissolved over a period of approximately 5 minutes. The flask was capped and the mixture sample was warmed almost to boil. When thoroughly mixed, the urine solutions were filtered using a vacuum filtration device with a 0.45 μm nylon membrane filter. The synthetic urine was stored in the Erlenmeyer flask and placed in a refrigerator. The mixture was allowed to warm to room temperature before use.

The volume of synthetic urine prepared for a given experiment was based on the amount of urine that would be collected in a two urinal restroom serving 10 male adults who would visit the restroom four times over an eight-hour period, with each urination discharging 220 mL over a period of 15 seconds. In the intermittent flow experiment 220 mL of synthetic urine was poured through a waterless urinal during 15 second period, and the urination event was repeated every 24 min for 8 hours/day for 4 days, for a total throughput of 17.6 L of urine.

### Intermittent Flow Experiments

The experiments were completed under an intermittent flow regime for the purpose of simulating realistic urinal usage. Evenly spaced simulated urination events of 220 mL was performed every 24 minutes over an eight hour period, with flow over a time span of 15 seconds, which is a flow rate of 15 mL/second. The volume of fresh urine samples was measured using a 500 mL graduated cylinder, and the urine collected in a 250 mL Erlenmeyer flask was measured using a 500 mL graduated cylinder. No urine exited the urinal after the first urination event, with the first recovered sample exiting the absorption device after the second urination event. A full 220 mL sample was collected after the fourth simulated urination event in each of the three trials. The elapsed time between simulated urinal use days was not consistent between the three intermittent flow experiments. The different “resting time” for the three reactors could have affected the removal capacity of the resin. Table 2 documents the elapsed resting time between each simulated urinal use day.

TABLE 2
Resting time following runs 1-3 for each replicate trial of
intermittent flow hardness removal experiment

| | Resting Time (d): | | |
|---|---|---|---|
| | “Day 1” | “Day 2” | “Day 3” |
| Trial 1 | 3 | 8 | 2 |
| Trial 2 | 6 | 12 | 2 |
| Trial 3 | 15 | 9 | 6 |

### Analytical Methods

Calcium and magnesium were measured using standard titration methods for calcium and total hardness. Magnesium concentrations were determined by subtracting the calcium hardness from total hardness. Three buffers were used: NH₄Cl; MgEDTA; and NH₄OH. Calgamite solution (1 g/L) and Blue-Black R Eriochrome (0.5%) were used as indicators for total and calcium hardness titrations, respectively. The pH of each sample was tested using an Acumet AP71 instrument. Diclofenac concentrations were analyzed using a Hitachi U-2900 Spectrophotometer with a peak absorbance at a wavelength of 275 nm. A calibration curve was prepared using 5 standard solutions of diclofenac. Samples were resin supported, diluted ten-fold, and measured in triplicate.

### Ca and Mg Removal: Intermittent Flow

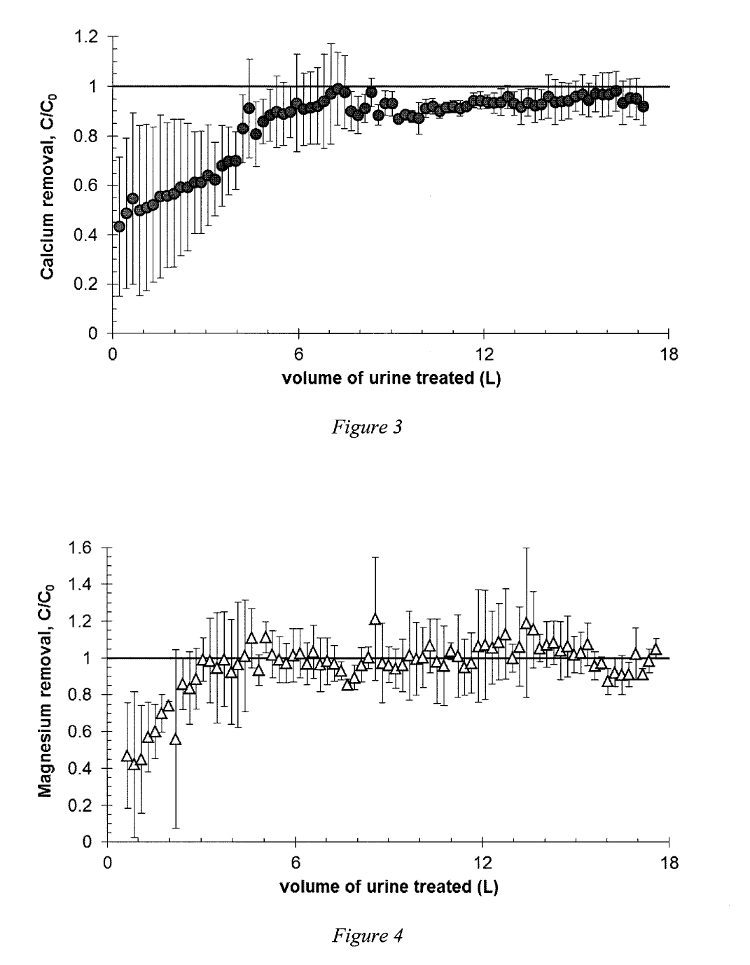

Three intermittent flow experiments examined calcium and magnesium hardness over the course of four simulated eight-hour periods, which was the period at which the first experiment displayed “breakthrough” after total introduction of 17.6 L of simulated urine. FIGS. 3 and 4, respectively, show average calcium and magnesium removal vs. cumulative volume of synthetic urine treated. Breakthrough is displayed (red line) as the concentration ratio C/C₀=1, where the inlet ion concentration is equal to outlet ion concentration. Error bars in these figures represent standard deviation between the three replicate experiments. FIGS. 3 and 4 suggest that the ion exchange resin reaches breakthrough more quickly for magnesium than for calcium. Compared to magnesium, calcium removal data show greater error at low cumulative volumes and less error at high cumulative volumes. Magnesium concentrations were determined by the difference in total and calcium hardness titrations whereas the calcium concentrations were based only on calcium hardness titrations.

### Diclofenac Removal: Intermittent Flow

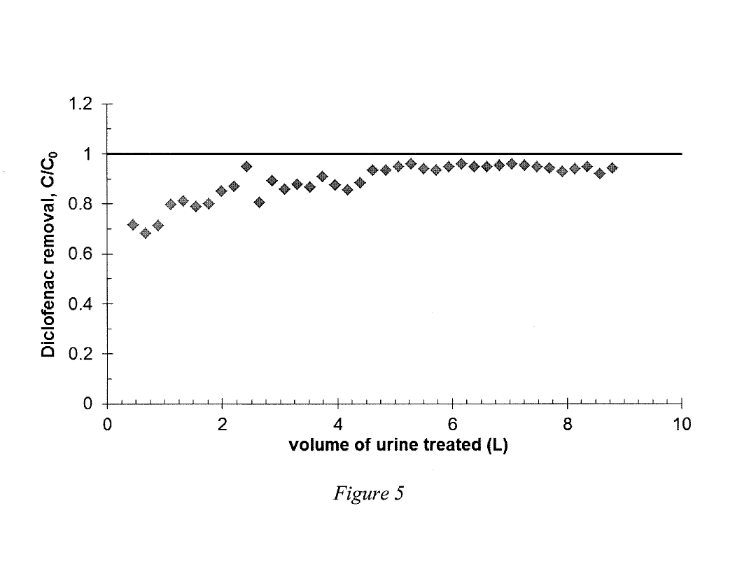

Diclofenac was added at a concentration of 1 mmol/L to the synthetic urine composition used in the Ca and Mg removal experiments. Untreated urine was poured through following the same intermittent flow procedure as described above, with samples collected after each 220 mL pour through. Diclofenac was analyzed using UV spectrophotometry. FIG. 5 shows the Diclofenac removal vs. cumulative volume of synthetic urine treated. Diclofenac removal diminished severely after just over 2 L of urine.

Removal of Diclofenac from Urine Studies

### Synthetic Human Urine

The composition of each urine condition is shown in Table 3, below. Fresh urine contained urea, sodium, potassium, magnesium, calcium, chloride, and sulfate at pH 6. Phosphate and citrate were present in fresh urine and hydrolyzed urine for select experiments. Urine was filtered to remove any undissolved salts. Diclofenac sodium was used, which has pKa of 4.24. The initial concentration of diclofenac was 0.1 mM in preliminary experiments and was increased to 0.2 mM in most other experiments. The initial diclofenac concentrations were selected to represent the concentration of diclofenac, as representative of levels of other pharmaceuticals present in human urine.

TABLE 3
Composition of fresh urine

| Chemical | Fresh urine |
|---|---|
| CH₄N₂O (urea), mmol/L as N | 500 |
| NaCl, mmol/L | 44 |
| Na₂SO₄, mmol/L | 15 |
| KCl, mmol/L | 40 |
| NH₄OH, mmol/L | — |
| MgCl₂•6H₂O, mmol/L | 4 |
| Na₂HPO₄•7H₂O^{a} or | 0.2, 20 |
| NaH₂PO₄, ^{a,}mmol/L as P | |
| CaCl₂•2H₂O, mmol/L | 4 |
| NH₄HCO₃, mmol/L | — |
| NaC₁₄H₁₀Cl₂NO₂ (diclofenac), | 0.1, 0.2 |
| mmol/L | |
| Na₃C₆H₅O₇•2H₂O (citrate)^{a}, | 0.067 |
| mmol/L | |
| pH | 6 |

^{a}Present in select experiments

### Anion Exchange Resins and Preparation

Strong-base polymeric anion exchange resins (AER) were used in experiments, as indicated in Table 4, below. A-520E resin was used in the majority of experiments. The effect of resin properties including pore structure, polymer composition, and functional group was evaluated. Each batch of AER was regenerated in NaCl solution, which contained 100× more Cl− ions than ion-exchange sites available on the AER (calculated based on ion-exchange capacity from manufacturer). The slurry was mixed for 1 h before rinsing the AER repeatedly with DI water. Anion exchange resin was dosed by mass instead of volume because small amounts of AER were used in batch experiments; the density of AER was used to relate mass to volume. Regenerated wet AER was measured in graduated cylinders and placed in separate weigh dishes and dried in a desiccator for several days until constant dryness. The dishes containing dried AER were weighed and averaged (n=3) to determine the mass of 1 mL of wet AER; the density was used to calculate the mass of AER required for a given volume.

TABLE 4
Properties of anion exchange polymer resins used in ion-exchange experiments.

| | | | | Capacity^{a} | Density^{b} |
|---|---|---|---|---|---|
| Resin | Pore Structure | Polymer | Functional group | (meq/mL) | (g/mL) |
| Purolite | macroporous | styrene | R—N+(C2H5)3, | 0.9 | 0.323 |
| A-520E | | | triethylamine | | |
| Dowex 22 | macroporous | styrene | R—N+(CH3)2(CH2OH), | 1.2 | 0.317 |
| | | | dimethylethanolamine | | |
| Dowex | gel | styrene | R—N+(CH3)3, | 1.3 | 0.322 |
| Marathon 11 | | | trimethylamine | | |
| Amberlite | macroporous | acrylic | R—N+(CH3)3, | 0.8 | 0.222 |
| IRA958 | | | Trimethylamine | | |

^{a}Manufacturer data.
^{b}Determined experimentally.

### Batch Kinetic Tests

A batch kinetic test was conducted using A-520E resin to determine the equilibrium time for diclofenac removal, as indicated as K.1, in Table 5, below. The kinetic test was performed in duplicate using fresh and hydrolyzed urine at an initial diclofenac concentration of 0.1 mM. A constant resin dose of 8 mL/L was added to 125 mL of urine in 125 mL Erlenmeyer flasks. The flasks were placed on a multi-place stir plate and mixed using a magnetic stir bar at 500 rpm and removed at predetermined contact times (5 min, 30 min, 1 h, 2 h, 6 h, 1 d, 2 d). The samples were filtered to separate resin from solution, and analyzed for diclofenac and pH.

### Batch Equilibrium Tests

Batch equilibrium tests were performed in triplicate to investigate the ion-exchange behavior of diclofenac. The experimental conditions are shown in Table 5, below. Similar to the kinetic test, 125 mL of urine was added to 125 mL Erlenmeyer flasks and varying amounts of dried AER were added; the corresponding volume of wet AER was 1, 2, 4, 8, and 16 mL/L. Samples were mixed on a multi-place stir plate at 500 rpm for 24 h and filtered before being analyzed for diclofenac and pH. The initial diclofenac concentration was either 0.1 mM or 0.2 mM. Batch equilibrium tests were also used to evaluate the effect of competing species on diclofenac ion-exchange. For experiments E.3 and E.4 (Table 5), phosphate was added in varying concentrations. For the low phosphate concentrations (E.3, Table 5) the purpose was to investigate the direct competition for ion-exchange sites with diclofenac based on equivalent concentrations of phosphate and diclofenac. In fresh urine, (pH 6) phosphate is present in the monovalent form (H2PO4. For phosphate to have an equivalent concentration to diclofenac, 0.2 mM as P was added to fresh urine. A realistic concentration of phosphate in fresh urine is approximately 20 mM as P so this condition was investigated. A natural organic metabolite and potentially competing species investigated was citrate (E.5, Table 5) Following the same method as phosphate and considering citrate charge density of 3 meq/mmol, the citrate concentration in urine was 0.067 mM.

TABLE 5
Experimental conditions
for ion-exchange kinetic tests and equilibrium tests.

| Kinetic (K) or Equilibrium (E) | Resin | DCF | PO₄—P | citrate |
|---|---|---|---|---|
| K.1 | A520E | 0.1 | — | — |
| E.1 | A520E | 0.1 | — | — |
| E.2 | A520E | 0.2 | — | — |
| E.3 | A520E | 0.2 | 0.2 | — |
| E.4 | A520E | 0.2 | 20 | — |
| E.5 | A520E | 0.2 | — | 0.067 |
| E.6 | — | — | — | — |
| E.7 | Dowex 22 | 0.2 | — | — |
| E.8 | Marathon 11 | 0.2 | — | — |
| E.9 | IRA958 | 0.2 | — | — |
| E.10^{a} | A520E | 0.2 | — | — |

Diclofenac (DCF),
All concentrations are mmol/L,
^{a}Diclofenac in DI water.

### Analytical Methods

The synthetic urine was filtered before and after all tests using either 0.45 μm membrane filter (Millipore Durapore) or type A/E glass fiber filter (Gelman Sciences), both of which are sufficient to separate particulate impurities and resin from urine. Diclofenac concentrations were measured using UV absorbance on a U-2900 UV-visible spectrophotometer (Hitachi High Technologies) and 1 cm quartz cuvette. An initial wavelength scan of samples containing 0.1 mM diclofenac in fresh urine was conducted to determine the wavelength for maximum UV absorbance, which was determined as 275 nm. The calibration curve for diclofenac was developed by making standards of increasing concentration (0.003, 0.013, 0.025, 0.050, 0.10, and 0.20 mM) from diclofenac stock solution and measuring the UV absorbance. The coefficient of determination (R2198) was ≧0.999 for all calibration curves. Quality control tests were performed to ensure that phosphate and citrate did not interfere with measurement of diclofenac. The results are shown in Table 6, below. There was a very slight decrease in the measured diclofenac concentration when phosphate was present, as shown in CS2 (Table 6). This was likely due to the lower pH (pH 5), which caused a small fraction of diclofenac to precipitate out of solution resulting in a lower absorbance. Raising the pH to 8.3 increased the UV absorbance but it was still less than CS1 (Table 6). Citrate did not interfere with measurement of diclofenac.

TABLE 6
UV absorbance of diclofenac
in the absence and presence of phosphate and citrate.

| | | | | | Measured |
|---|---|---|---|---|---|
| Check | DCF, | PO₄—P, | Citrate, | Measured | DCF, |
| standard | mmol/L | mmol/L | mmol/L | absorbance | mmol/L |
| CS1 | 0.1 | — | — | 0.094 | 0.102 |
| CS2 | 0.1 | 5 | — | 0.916 (pH 5) | 0.094 (pH 5) |
| | | | | 0.960 (pH 8.3) | 0.098 (pH 8.3) |
| CS3 | 0.1 | — | 0.067 | 0.997 | 0.102 |
| CS4 | — | 5 | — | −0.003 | 0 |
| CS5 | — | — | 0.067 | −0.003 | 0 |

Diclofenac (DCF).

Phosphorous concentrations were measured using the ascorbic acid method following Standard Methods 4500P using a U-2900 UV-visible spectrophotometer (Hitachi High Technologies) at a wavelength of 880 nm and a 1 cm quartz cuvette. The calibration curve for phosphate was developed using standards of increasing concentrations (0.15, 0.30, 0.60, and 1.20 mg/L as P) made from a 50 mg/L stock solution of either Na2HPO4.7H2O or NaH2PO4. For the low phosphate concentrations (0.2 mM and 0.1 mM as P) samples of fresh urine required a 1:4 dilution; for the high phosphate concentrations (20 mM and 5 mM as P) samples of fresh urine required a 1:500 dilution. Citrate concentrations were analyzed by measuring the dissolved organic carbon concentration using a Shimadzu TOC-VCPH equipped with an ASI-V autosampler. Samples for citrate analysis were measured in duplicate, calibration check standards agreed with known concentration with <10% difference and duplicate measurements showed <5% difference. Samples for citrate analysis that had a relative difference >30% were excluded from results. Several samples had final phosphate (or citrate) concentration greater than initial phosphate (or citrate) concentration; in these cases, the final concentration was set equal to initial concentration and yielded 0% removal.

Chloride and sulfate concentrations were measured using ion chromatography (Dionex ICS-3000). Samples from E.7 (Table 5) for fresh urine and hydrolyzed urine were measured for chloride and sulfate and required a 1:31 dilution. Samples from the equilibrium test where only diclofenac was present in DI water did not require dilution for chloride analysis (E.10, Table 3). pH was measured after each experiment using an Accumet AB-15+ pH meter and pH/ATC probe. The pH meter was calibrated prior to each use with 4, 7, and 10 buffer solutions.

### Data Analysis

Data from kinetic tests are the mean value of duplicate samples. Data from equilibrium tests are the mean value of triplicate samples. Paired-sample t-tests were performed using MATLAB (7.10.0 R2010A). The null hypothesis was that the difference in paired samples had mean equal to 0; the alternative hypothesis was that the difference in paired samples had mean not equal to 0. Hypothesis tests were conducted at the 5% significance level.

### Diclofenac Ion-Exchange in Fresh and Hydrolyzed Urine

### Batch Kinetic Tests

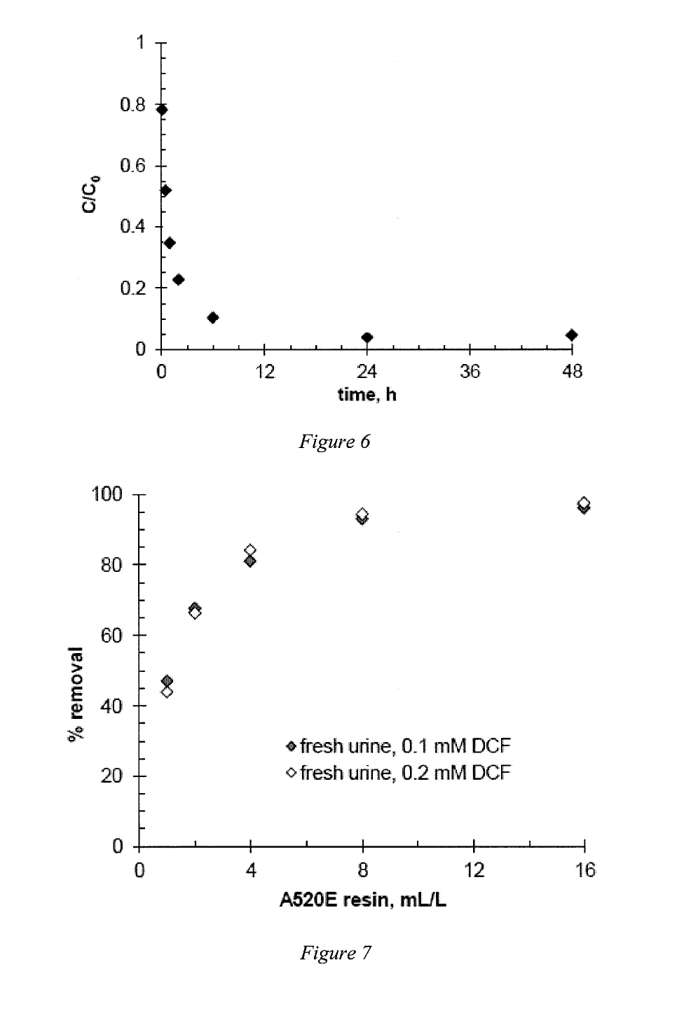

Kinetic tests were carried out in fresh urine to investigate the removal rate of diclofenac by A520E resin (K.1, Table 5). FIG. 6 shows the decrease in diclofenac concentration due to ion-exchange removal at different mixing times in fresh urine where the data points are normalized concentration. The rate of diclofenac removal followed a two-step process in which rapid removal takes place within the first 1 h showing >60% removal. The rate of removal after 1 h was much slower and reached equilibrium in 24 h with 96% removal in fresh urine. The two-step removal rate is common for adsorption to macroporous and mesoporous materials, such as polymer resins, where external surface sites are occupied first and internal surface sites are occupied later through intraparticle pore diffusion.

### Batch Equilibrium Tests

Equilibrium tests were performed to investigate the effect of varying A520E resin dose, initial diclofenac concentration, and urine composition on diclofenac removal (E.1 and E.2, Table 5). FIG. 7 shows the removal of diclofenac in fresh urine at initial diclofenac concentrations of 0.1 mM and 0.2 mM. Diclofenac removal was approx. 40% to 50% using 1 mL/L of A520E resin. Theoretically, 1 mL/L of A520E resin is equivalent to 0.9 meq/L of ion-exchange capacity, which should be sufficient excess capacity to remove 0.1 or 0.2 meq/L diclofenac from solution. Less than complete removal of diclofenac at 1 mL/L of A520E resin indicates that inorganic anions are inhibiting diclofenac ion-exchange. A520E resin was selected for this study because the triethylamine functional group is reported to make the resin more selective for monovalent anions over divalent anions. The chloride concentration in urine was approx. 110× greater than the ion-exchange capacity at 1 mL/L of A520E resin and 1000× greater than the initial diclofenac concentration of 0.1 mM. It appears that a combination of high concentrations of sulfate and chloride in urine can limit ion-exchange sites available are responsible for the lower removal of diclofenac observed than predicted based on ion281 exchange capacity.

As the amount of A520E resin was doubled from 1 mL/L to 2 mL/L, diclofenac removal increased by ˜20%. Similarly, as the amount of A520E resin was doubled from 2 mL/L to 4 mL/L, diclofenac removal increased by ˜20%. As the amount of A520E resin was increased from 4 mL/L to 8 mL/L and subsequently from 8 mL/L to 16 mL/L there was only approx. 10% increase in removal. Diclofenac removal increased as the amount of A520E resin increased because the conditions for diclofenac ion-exchange became more favorable in terms of sulfate and chloride concentrations relative to ion-exchange sites. The t-tests indicated that the initial diclofenac concentration did not affect diclofenac removal in fresh urine.

An equilibrium test was conducted using A520E resin and DI water containing 0.2 mM diclofenac to confirm that ion-exchange (i.e., electrostatic interactions) was the main mechanism of diclofenac removal (E.10, Table 5). The increase in chloride concentration in urine due to ion exchange removal of diclofenac (E.2, Table 5) could not be measured accurately because of the high initial concentration of chloride (˜3500 mg/L). Assuming complete removal of diclofenac at initial concentration of 0.2 mM, the chloride released from the resin through stoichiometric exchange would be ˜7 mg/L so the chloride concentration in urine would increase by ˜0.2%. For this reason the equilibrium test in DI water allowed for quantitative measurement of the chloride increase due to diclofenac exchange with chloride. Results confirmed that stoichiometric exchange was the mechanism of removal where chloride concentrations ranged from 7 to 9 mg/L and almost 100% removal of diclofenac was measured at all AER doses. The complete removal of diclofenac in DI water by A520E resin at all AER doses was consistent with the theoretical ion-exchange capacity in the absence of competing inorganic anions.

### Effect of Phosphate and Citrate

Diclofenac Competition with Phosphate and Citrate

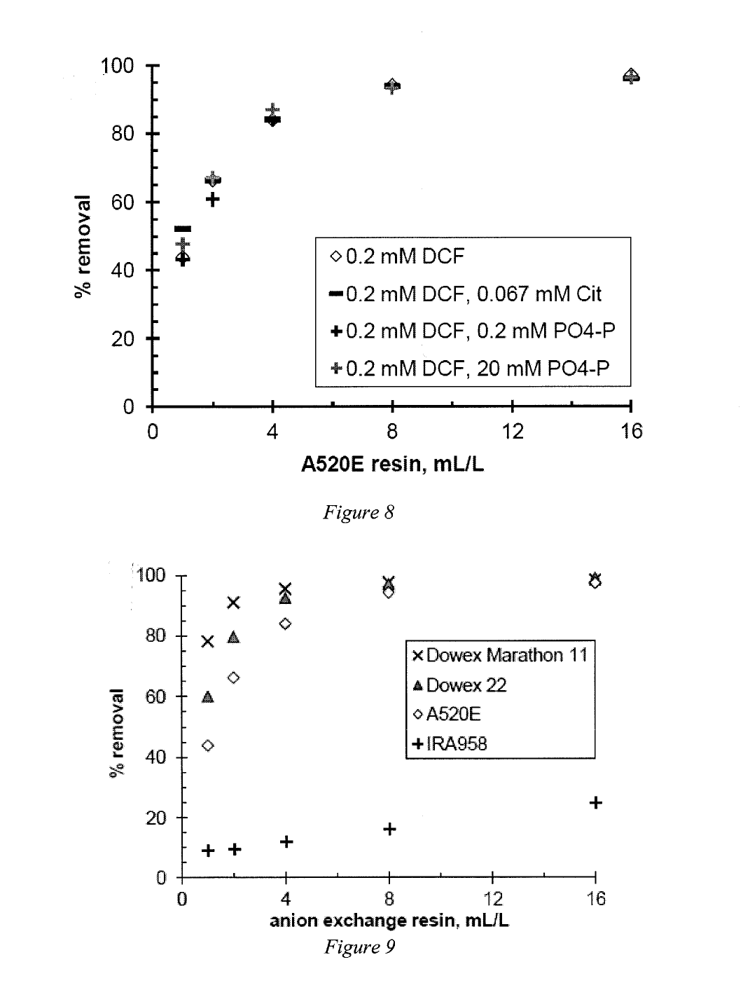

Because ion-exchange was determined to be the mechanism of diclofenac removal and diclofenac removal was higher in DI water than urine, the next question was whether other anions present in urine, particularly phosphate and natural organic metabolites, would compete with diclofenac for ion-exchange sites. Citrate was studied as a model natural organic metabolite because it is present in urine at concentrations greater than pharmaceuticals and is anionic with three deprotonated oxygen atoms. FIG. 8 shows the removal of diclofenac as a function of A520E resin dose in fresh urine when the competing species phosphate or citrate were present. In fresh urine, the presence of either phosphate or citrate had <10% effect on diclofenac removal with the most noticeable effect at A520E resin doses of 1 and 2 mL/L. For example, the presence of phosphate at equivalent concentration as diclofenac showed maximum difference of 6% lower diclofenac removal. The presence of citrate at equivalent concentration as diclofenac showed maximum difference of 8% higher diclofenac removal.

### Co-Removal of Phosphate and Citrate by Ion-Exchange

Phosphate concentrations were measured for experiments E.3 and E.4 (Table 5) for fresh urine (results not shown). For experiment E.3 the highest phosphate removal was approx. 2% in fresh urine and 11% in hydrolyzed urine. For experiment E.4 the highest phosphate removal was approx. 20% in fresh urine. The low phosphate removal by A-520E resin was expected because phosphate is not effectively removed by electrostatic interactions (i.e., ion-exchange) and instead prefers ligand exchange with metals such as Fe. A-520E resin is designed to be nitrate selective in the presence of high sulfate concentrations, which likely explains why the AER was not selective for citrate. Diclofenac, like nitrate, has one negative charge to promote ion-exchange. The triethylamine functional groups of A-520E resin are designed to inhibit ion-exchange with sulfate, which has two negative charges; similarly citrate has three negative charges and suggests that ion-exchange would be difficult as well. Overall, diclofenac removal by A-520E resin was not affected by the presence of phosphate or citrate because of unfavorable electrostatic interactions between phosphate/AER and citrate/AER.

### Effect of Anion Exchange Resin Properties

FIG. 9 shows diclofenac removal using the various AERs in fresh urine and hydrolyzed urine. At 1 mL/L of AER, the order of diclofenac removal in fresh urine was Dowex Marathon 11 (78%)>Dowex 22 (60%)>A520E (44%)>IRA958 (9%). Removal of diclofenac by the different AERs followed the same order in hydrolyzed urine as fresh urine with approx. 5% lower removal for all AERs. The order of diclofenac removal by the different AERs from highest removal to lowest removal was the same order as decreasing ion-exchange capacity (Table 4). Thus, one of the major factors for the different levels of diclofenac removal at constant dose of AER, especially at AER doses of 1, 2, and 4 mL/L, was because of differing ion-exchange capacity. At AER doses of 8 and 16 mL/L, diclofenac removal was approximately equal for the three polystyrene AERs (Dowex Marathon 11, Dowex 22, and A520E) because ion-exchange capacity was in excess. For example, diclofenac removal was 94% to 98% in fresh urine using 8 mL/L of polystyrene AER, which corresponded to 7.2 to 10.4 meq/L of ion-exchange capacity. The polyacrylic AER (IRA958) showed much lower removal of diclofenac in comparison with the polystyrene AERs; the reason for this behavior is discussed in the next paragraph. A paired test was conducted to compare statistically diclofenac removal among the different AERs in fresh urine and hydrolyzed urine, and in all cases, the null hypothesis of no significant difference in diclofenac removal between different AERs was rejected (results not shown). Because each AER had a different ion-exchange capacity, the volumetric dose of AER can be converted to an equivalent-based dose (meq resin/L solution) by multiplying the volumetric dose (mL resin/L solution) by the ion-exchange capacity (meq resin/mL resin). At a constant equivalent-based dose of AER (<8 meq/L), the order of diclofenac removal was Dowex Marathon 11>Dowex 22>A520E>>IRA958. At a constant equivalent-based dose of AER (>8 meq/L), the order of diclofenac removal was Dowex Marathon 11≈Dowex 22≈A520E>>IRA958. It is important to emphasize that the order of diclofenac removal is independent of ion exchange capacity, and rather, is a function of polymer composition (polystyrene vs. polyacrylic), pore structure (gel vs. macroporous), and functional group (trimethylamine, triethylamine, dimethylenthanolamine) with polymer composition having the most pronounced effect.

With respect to the polystyrene AERs, Dowex Marathon 11 has a gel pore structure whereas Dowex 22 and A520E have macroporous pore structure. Gel-type resins consist of a homogenous solid polymer-phase containing evenly distributed ion-exchange sites, in contrast, macorporous resins are a dual-phase material containing solid polymer-phase and liquid-filled pores. One explanation for the higher diclofenac removal by the polystyrene gel resin than polystyrene macroporous resins was because the solid polymer-phase of the gel resin allowed for more non-electrostatic interactions between resin matrix and diclofenac.

### Phosphate Ion Exchange

### Synthetic Human Urine

The fresh urine composition is shown in Table 7, below. Synthetic urine was filtered through 0.45 μm filters to remove any undissolved particles. Urine was stored at 4° C. until used in experiments.

TABLE 7
Chemical compositions of urine

| Component/Property | Unit | Quantity |
|---|---|---|
| Na⁺ | mmol/L | 74 |
| K⁺ | mmol/L | 50 |
| Ca²⁺ | mmol/L | 4 |
| Mg²⁺ | mmol/L | 4 |
| NH₄⁺—N^{a} | mmol/L | |
| Cl⁻ | mmol/L | 100 |
| HCO₃⁻—C^{a} | mmol/L | |
| SO₄²⁻ | mmol/L | 10 |
| PO₄²⁻—P^{a} | mmol/L | 20 |
| Urea-N^{a} | mmol/L | 500 |
| pH | | 6 |
| Volume | L p⁻¹ d⁻¹ | 1.4^{a} |
| Ionic strength | mol/L | 0.145 |

^{a}Assumes 7 voids per day and 200 mL of urine per void.

### Hybrid Anion Exchange Resin

The HAIX resin used has the commercial name PhosX 161 or LayneRT and is manufactured by SolmeteX (Northborough, Mass.). HAIX resin is a strong-base anion exchange resin impregnated with hydrated ferric oxide (HFO) nanoparticles, which undergo ligand exchange with phosphate. HAIX resin has a particle size of 300-1200 μm based on manufacturer data. No regeneration was required for the resin and the resin was used as received. The only preparation was rinsing the resin with DI water to get rid of fines or broken resin beads. The resin was measured as the volume of wet settled resin using a graduated cylinder. A small amount of DI water was used to transfer resin from graduated cylinders to sample bottles. The density of the resin was 0.386 g of dry resin per 1 mL of wet settled resin.

### Kinetic Tests

A long-term kinetic test was performed using fresh urine and hydrolyzed urine at a constant resin dose to determine the equilibrium time. All kinetic tests were conducted at ambient laboratory temperature (approx. 23° C.). The fresh urine had a resin dose of 100 mL/L Samples consisted of resin and 100 mL of synthetic urine in 250 mL amber glass bottles. Samples were mixed on a shaker table at 200 rpm for 5 min, 30 min, 1 h, 2 h, 6 h, 1 d, and 2 d. samples were tested in duplicate. Samples were filtered immediately after mixing using 0.45 μm filters to separate resin from solution. pH and phosphate were measured for all treated samples and control samples. The control samples consisted of either fresh urine with no resin and were mixed for the maximum duration of the experiment. An equilibrium time of 2 h was established. The long-term kinetic study was repeated using three different resin doses (50, 100, and 200 mL/L), and mixing times of 1 h, 2 h, 6 h, and 1 d. Samples were tested in triplicate. A short-term kinetic test was performed using fresh urine at a constant resin dose to investigate how much phosphate is removed in the first 5 min of mixing. Fresh urine had a resin dose of 100 mL/L. Samples were run in triplicate at times of 1, 2, 3, 4, 5, 10, 20, and 60 min. Each mixing time also had its own control sample, i.e., urine with no resin. Samples were filtered immediately after mixing using 0.45 μm filters to separate resin from solution. pH and phosphate were measured for all treated samples and control samples. Samples were tested in triplicate. A short-term kinetic study was also performed using fresh urine at a constant resin dose to investigate the effect of no mixing. Fresh urine had a resin dose of 100 mL/L. Samples were allowed to stand but not mix for 1, 5, and 10 min, after which time the samples were filtered through 0.45 μm filters, and analyzed for pH and phosphate. Samples were tested in triplicate.

### Equilibrium Tests

Equilibrium tests were performed using fresh urine at several resin doses. All equilibrium tests were conducted at ambient laboratory temperature (approx. 23° C.). Samples were mixed for 2 h on a shaker table at 200 rpm. Fresh urine used resin doses of 20, 50, 100, 200, 300, 400, and 500 mL/L. Samples were run in triplicate with control samples (no resin).

Five additional equilibrium tests were conducted as described in the previous paragraph using different compositions of urine: 2× sulfate concentration in fresh urine, 0.2 mmol/L diclofenac in fresh urine. The equilibrium tests using 2× sulfate and diclofenac used the same resin doses as listed in the previous paragraph. Samples were run in triplicate.

### Analytical Methods

Phosphate was measured following the Ascorbic acid method 4500-P on a Hitachi U-2900 UV-visible spectrophotometer at 880 nm. A 1 cm quartz cuvette was used. The initial calibration curve was DI water blank (i.e., 0 mg/L), 0.2, 0.4, 0.8, and 1.6 mg/L. The calibration curve was refined during the equilibrium tests to DI water blank, 0.15, 0.3, 0.6, and 1.2 mg/L. The calibration points were prepared from a 50 mg/L phosphate stock solution. The stock solution was made from an anhydrous potassium phosphate salt, KH₂PO₄. All urine samples had to be diluted so the phosphate concentration was within the calibration curve. Samples were diluted using DI water. Final concentrations reported are corrected for dilution. All phosphate concentrations are as P, i.e., mg P/L.

Diclofenac was measured on a Hitachi U-2900 UV-visible spectrophotometer at 275 nm using a 1 cm quartz cuvette. The calibration curve was 0.003, 0.013, 0.025, 0.050, 0.10, and 0.20 mM as diclofenac. Calibration points were prepared from a 1000 mg/L diclofenac stock solution, which was prepared by dissolving diclofenac sodium in DI water. UV absorbance followed a linear response to diclofenac concentration over the concentration range 0.003-0.2 mM. Samples did not require dilution. Sulfate and chloride were measured by conductivity detection on a Dionex ICS-3000 ion chromatograph. The sulfate calibration curve was 0.5, 2.5, 5, 25, and 50 mg/L prepared from 1000 mg/L sulfate stock solution, which was prepared by dissolved Na₂SO₄ in DI water. The chloride calibration curve was 2, 10, 20, 100, and 200 mg/L prepared from 1000 mg/L chloride stock solution, which was prepared by dissolving NaCl in DI water. Operating conditions were as follows: IonPac AG22 guard column and AS22 analytical column; anion self-regenerating suppressor set to 31 mA; column and detector compartments set to 30° C.; eluent composition 4.5 mM Na₂CO₃/1.4 mM NaHCO₃ (AS22 eluent concentrate, Dionex); eluent flow rate 1.2 mL/min; and 25 μL sample loop. Samples were diluted using DI water. pH was measured using Accumet AB-15+pH meter. Quality control was monitored by measuring control samples and original synthetic urine that was stored in the refrigerator.

### Kinetic Test Results

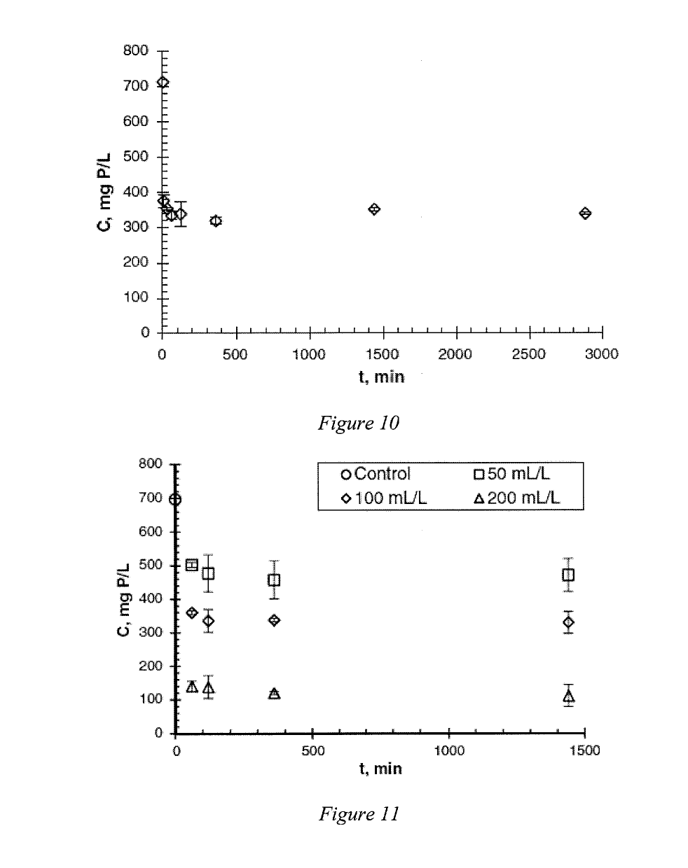

FIG. 10 shows the results from the long-term kinetic test for fresh urine. The fresh urine had an initial phosphate concentration of 712 mg/L and HAIX resin dose of 100 mL/L. Most of the phosphate removal was achieved in the first 5 min of the experiment with 47% removal in fresh urine. After 60 min of mixing in fresh urine the phosphate concentration was constant at 312 mg/L giving removal of 52%. The long-term kinetic test was repeated using fresh urine to evaluate the effect of mixing time and resin dose on phosphate concentration and equilibrium time as shown in FIG. 11. Three HAIX resin doses were tested: 50, 100, and 200 mL/L; samples were collected after mixing at 321 200 rpm for 1 h, 2 h, 6 h, and 1 d; the initial phosphate concentration was 698 mg/L. The time-varying removal of phosphate followed the same trend for all three resin doses. Most of the phosphate removal occurred in 1 h and steady-state phosphate removal was achieved by 2 h. Steady-state removal of phosphate increased with increasing resin dose with 32% removal at 50 mL/L, 52% removal at 100 mL/L, and 80% removal at 200 mL/L.

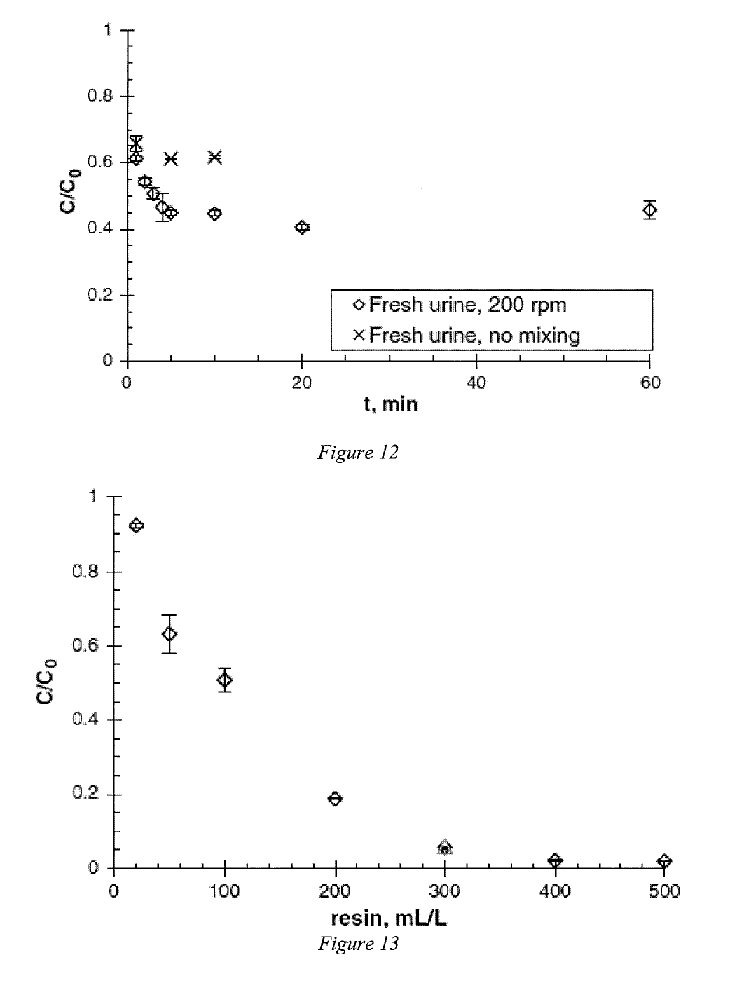

The rapid removal of phosphate shown in FIG. 10 was further investigated by conducting a short-term kinetic test (FIG. 12). Samples were collected after mixing at 200 rpm for 1, 2, 3, 4, 5, 10, 20, and 60 min. The fresh urine had an initial concentration of 714 mg/L with HAIX resin dose of 100 mL/L. HAIX resin showed rapid removal of phosphate in the first 5 min of mixing in fresh urine. For instance, there was 39% phosphate removal in the first 1 min of mixing with maximum phosphate removal of 54% at 60 min. Phosphate removal at 10 min and 60 min were in agreement between the long-term kinetic test (FIG. 10) and short-term kinetic test (FIG. 12).

To evaluate the effect of mixing on phosphate removal by ion-exchange, the short-term kinetic test was repeated where samples of urine and HAIX resin were not mixed but were in contact for 1, 5, and 10 min (FIG. 3). There was some phosphate removal with a maximum removal of 38% in fresh urine for 10 min of contact. This removal is attributed to the mixing that occurs when the samples are filtered to separate the urine from the resin.

### Equilibrium Test Results

The equilibrium tests evaluated the effect of resin dose and urine composition on phosphate removal. Fresh urine (pH 6) required a doses of HAIX resin ranging from 20 mL/L to 500 mL/L, because for an initial phosphate concentration at 675 mg/L. FIG. 13 shows the normalized phosphate concentration given the resin dose for the fresh, hydrolyzed, and theoretical hydrolyzed urine after mixing at 200 rpm for 2 h. The maximum amount of removal achieved was at the highest resin dose tested. HAIX resin showed 97% removal of phosphate in fresh urine.

The HFO in HAIX resin releases hydroxide as it forms inner-sphere complex with phosphate, and due to the ligand exchange mechanism, the pH in fresh urine increased with increasing resin dose because fresh urine lacked buffering capacity. The strong-base anion exchange sites were not responsible for the change in pH. Given fresh urine with an initial pH of 6, the maximum pH was 8.2, which corresponded to samples mixed with 500 mL/L resin for 2 h. The pH is an important consideration in phosphate removal because monovalent phosphate (H₂PO₄−) is the dominant species at pH 6 whereas divalent phosphate (HPO₄²⁻) is the dominant species at pH 8. In addition, as pH increases, the surface charge of HFO changes from positively charged FeOH₂⁺) to neutral (FeOH) to negatively charged ('FeO⁻). Based on the results in FIG. 13, HAIX resin is able to remove monovalent and divalent forms of phosphate that bind to different HFO surface sites, effectively.

### Competition Among Sulfate, Chloride, and Phosphate

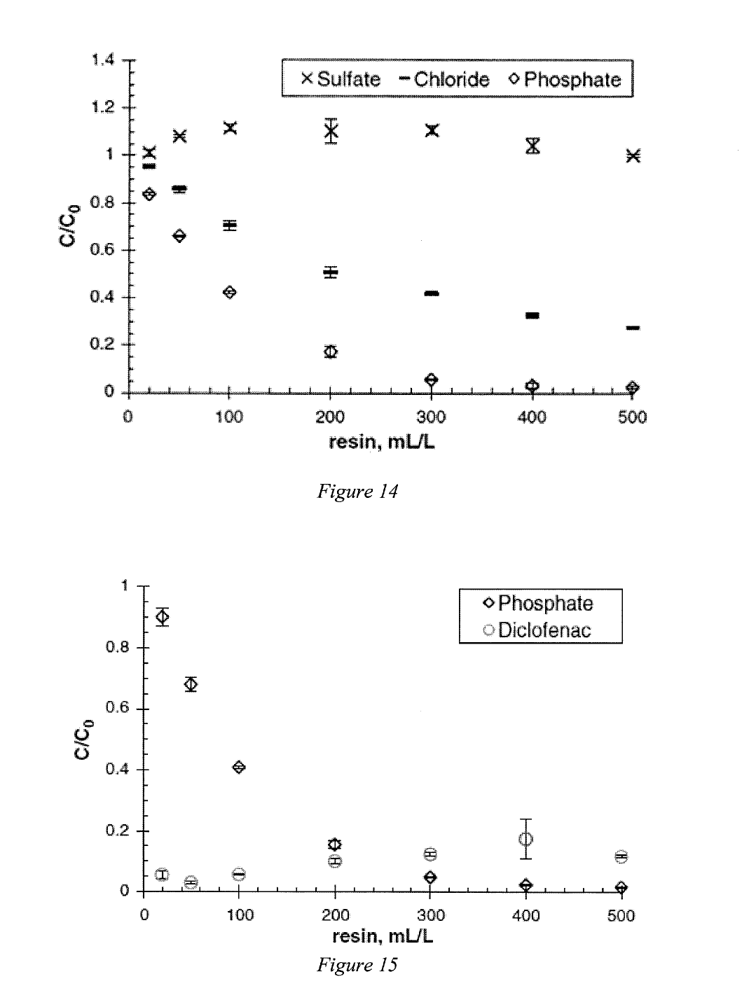

Sulfate and chloride were the most likely species to compete with phosphate for ion-exchange sites because of their negative charge and high concentration. The concentrations of chloride and sulfate following ion-exchange in fresh urine was not measured because the focus of the experiments was phosphate removal efficiency. Subsequent equilibrium tests were conducted in which the sulfate concentration was doubled for fresh urine. This made the molar ratio of sulfate:phosphate 1.5:1 in fresh urine. FIG. 14 shows the normalized concentration of sulfate, chloride, and phosphate following ion-exchange in fresh urine. Phosphate removal using HAIX resin was not affected by doubling the concentration of sulfate in fresh. For instance, there was less than 10% difference between phosphate removal in fresh urine at 15 and 30 mmol/L sulfate. The decrease in chloride concentration and increase in sulfate concentration is due to HAIX resin initially being in the sulfate form. This means that sulfate is the exchangeable ion associated with the quaternary ammonium strong-base anion exchange sites. In practice, HAIX resin is regenerated using caustic NaCl solution, which would convert HAIX resin to the chloride form. The expected result would be removal of sulfate and release of chloride due to ion-exchange. The HFO nanoparticles contained in HAIX resin make the resin selective for phosphate regardless of sulfate or chloride as exchangeable ion or present in solution.

### Co-Removal of Diclofenac and Phosphate

Equilibrium tests were conducted to determine the extent to which pharmaceuticals would be co-removed with phosphate. Diclofenac was used as a model pharmaceutical because it is excreted in urine, refractory to conventional wastewater treatment, and detected worldwide. Diclofenac is a non-steroidal anti-inflammatory drug that is completely deprotonated at pH>5. It is therefore a perfect candidate for ion-exchange.

FIG. 15 shows the normalized concentrations of phosphate and diclofenac following ion-exchange in fresh urine and hydrolyzed urine. Phosphate removal was not affected by the presence of diclofenac in fresh urine. The phosphate concentration was 100× higher than the diclofenac concentration in fresh urine. High removal of diclofenac using HAIX resin, up to 97% in fresh urine was achieved for all resin doses. Other negatively charged pharmaceuticals, such as ibuprofen, naproxen, and ketoprofen, are expected to be removed by HAIX resin following the results in FIG. 15.

All articles referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

I claim:

1. An absorption device, comprising:
an exchange container comprising a housing and at least one resin support; and
at least one ion exchange resin contained within the exchange container, wherein the absorption device is sized for insertion into the drain of a waterless urinal in a manner that directs the flow of liquid through the ion exchange resin, wherein the ion-exchange resin removes at least a portion of one or more cations or anions selected from: calcium; magnesium; dihydrogen phosphate; hydrogen phosphate; phosphate; pharmaceutical anion and an pharmaceutical metabolite.

2. The absorption device according to claim 1, wherein the ion exchange resin is a cation exchange resin.

3. The absorption device according to claim 1, wherein the ion exchange resin is an anion exchange resin.

4. The absorption device according to claim 1, wherein the ion exchange resin is a hybrid anion exchange resin.

5. The absorption device according to claim 1, wherein the ion exchange resin is a mixed bead ion exchange resin, a combination of a cation exchange resin and an anion exchange resin, or a combination of a cation exchange resin, an anion exchange resin, and a hybrid anion exchange resin.

6. The absorption device according to claim 5, wherein the housing comprises separate supports for different ion exchange resins.

7. The absorption device according to claim 1, further comprising a means for attachment, whereby the absorption device permits positioning in and/or securing to the drain of the waterless urinal.

8. The absorption device according to claim 7, wherein the means for attachment is threads of a screw.

9. The absorption device according to claim 1, further comprising an indicator bound medium, wherein a colorimetric indicator is bound within a solid support and attached to the exterior of the exchange container at the liquid exit of the absorption device and wherein the liquid is obliged to contact the indicator bound medium.

10. The absorption device according to claim 9, wherein the colorimetric indicator comprises calmagite.

11. A method of removing one or more ionic components from urine at a urinal, comprising:
providing at least one fresh absorption device according to claim 1;
positioning the fresh absorption device in the drain of a waterless urinal;
allowing the use of the urinal for a period of time, wherein the absorption device becomes a spent absorption device; and
replacing the spent absorption device after a period of use of a urinal, wherein replacement is done on a schedule or upon indication by the absorption device that it is at or near saturation of one or more ionic components.

12. The method of claim 11, further comprising regenerating the spent absorption device to yield a fresh absorption device, and, optionally, isolating one or more ionic components from the spent absorption device.
